(19) United States
(12) Patent Application Publication
(10) Pub. No.: US 2015/0298492 A1
(43) Pub. Date: Oct. 22, 2015

(54) METHOD AND MACHINE FOR THE DIGITAL DECORATION OF PRODUCTS WITH GRANULAR MATERIALS AND THE LIKE

(71) Applicant: PROJECTA ENGINEERING S.R.L., Fiorano Modenese (Modena) (IT)

(72) Inventor: Vincenzo Palumbo, Castellarano (Reggio Emilia) (IT)

(21) Appl. No.: 14/439,600

(22) PCT Filed: Apr. 17, 2013
(86) PCT No.: PCT/IB2013/053037

§ 371 Date: Apr. 29, 2015

(30) Foreign Application Priority Data
Sep. 4, 2012 (IT) VR2012A000177

(51) Int. Cl. B44C 1/00; B05D 1/38; B05C 21/00; B05D 5/00; B05C 19/04; B05D 1/12; B05D 3/06

(52) U.S. Cl. CPC B44C 1/00; B05D 1/12; B05D 1/38; B05D 3/065; B05D 5/00; B05C 19/04; B05C 21/00

(57) ABSTRACT

A machine for decorating products, including a digital printing head for applying, on the surface of the products to be decorated, at least one layer of fluid adhesive material, elements for depositing granular materials on the layer of adhesive material, and elements for removing the excess granular materials. A method for decorating products with granular materials and the like is also proposed.

### TECHNICAL FIELD OF THE INVENTION

The present invention concerns a machine and a method for the digital decoration of products with granular materials and the like.

More in particular, the present invention concerns a machine and a method for the digital decoration of products such as ceramic tiles and the like with granular materials and/or powders such as to create a decoration having also a certain material thickness.

### STATE OF THE ART

In some manufacturing fields, like for example the field of manufacturing products such as ceramic tiles and the like, the surfaces of the products themselves generally undergo processes of application of layers of decorative material which must give the end product the desired appearance, as well as the necessary mechanical resistance characteristics that are specific for the type of application.

As it is known, in the particular field of ceramic tiles, the visible surfaces of the products are decorated so as to obtain a great range of appearances, with the application of layers of decorative material—for example ink, glaze and the like, but also materials in the granular form like powders and the like—with a thickness that is usually quite limited and that is necessary to obtain a substantially flat decoration, or at least having elements such as slight reliefs or streaks that are obtained with known technologies.

In this particular field, but also in other manufacturing fields in which the products undergo the application of layers of decorative material, there is the desire to have surface decorations that are characterised also by a certain thickness, which can project three-dimensionally in the desired manner.

In other words, in the field, there is the desire to have decorations that give the product a certain effect that is markedly three-dimensional and solid that is completely new with respect to those which can be seen in products of the known type and already found on the market.

### SUMMARY OF THE INVENTION

The technical task of the present invention is therefore that of improving the state of the art.

In the field of such a technical task, one purpose of the present invention is to devise a machine for digitally decorating products that is suitable for making decorative patterns on the surface that are characterised by a certain thickness, which give the product itself a predetermined solid and three-dimensional appearance that is not yet possible to obtain with known surface decorating technologies.

Yet another purpose of the present invention is to make a machine for the digital decoration of products that is suitable for making surface decorative patterns by using, in particular, granular materials such as powders, granules, grits, flakes, and the like.

A further purpose of the present invention is that of devising a method for the digital decoration of products which makes it possible to obtain surface decorative patterns with the characteristics described above, in particular with a certain thickness that can project three-dimensionally in the desired manner and without the limitations imposed by the application of known technologies.

This task and these purposes are achieved by the machine for digitally decorating products with granular material and the like according to the present principles, and by the method for decorating products with granular materials and the like according to the present principles.

A machine according to the invention comprises a digital print head for applying, on the surface of the products to be decorated, at least one layer of fluid adhesive material, means for depositing granular material on the layer of adhesive material following irradiation, and means for removing the excess granular material.

A method according to the invention, put into practice with the aforementioned machine, thus comprises the steps of applying, on the surface of the products to be decorated, at least one layer of fluid adhesive material, depositing granular material on the layer of adhesive material, and removing the excess granular material.

The application of the method even many times over, so as to make various layers, that partially or totally overlap, of granular materials that are deposited in the specific desired areas, makes it possible to obtain surface decorations and not of any specific thickness, that can also be modified as desired, and which cannot be obtained with conventional decorative technologies.

This makes it possible to obtain decorations inside structures or recesses such as grooves or grains, that are impossible with conventional systems.

The present specification and claims refer to preferred and advantageous embodiments of the invention.

In particular, in one embodiment of a machine according to the invention, the digital print head is suitable for applying, on products to be decorated, a layer of fluid adhesive material of the type that can harden through exposure to radiation.

A machine is thus provided also with radiating means for irradiating the aforementioned layer of adhesive material applied to the digital print head.

### BRIEF DESCRIPTION OF THE DRAWINGS

The characteristics of the invention shall become clearer to any man skilled in the art from the following description and from the attached drawing tables, given as a non limiting example, in which:

FIG. 1 is a schematic side view of a machine for decorating products with granular materials and the like according to the present invention;

FIG. 2 is a schematic side view of another embodiment of the machine according to the present invention;

FIG. 3 is a schematic side view of yet another embodiment of the machine according to the present invention.

### DETAILED DESCRIPTION OF THE INVENTION

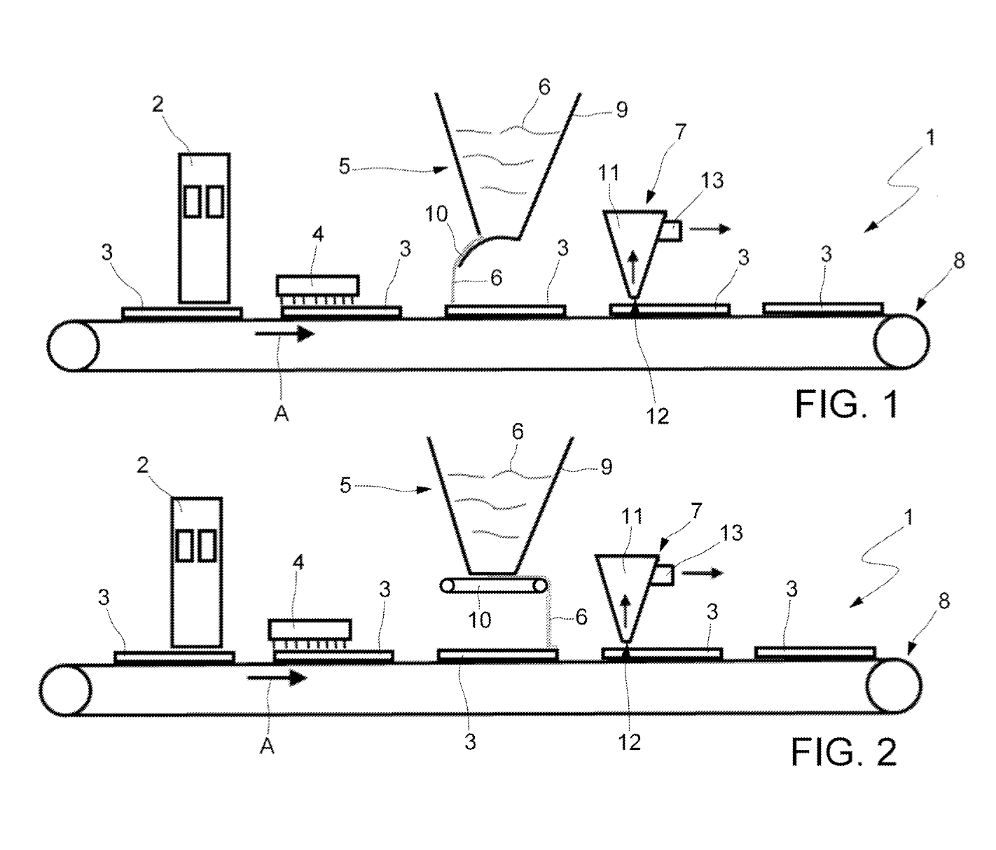

With reference to the attached FIG. 1, a machine for digitally decorating products with granular materials and the like according to the present invention is wholly and schematically shown with reference numeral 1.

The machine 1 according to the invention is particularly, but not exclusively, intended to be used for decorating flat products such as ceramic tiles, or other similar products.

It should however be noted that the machine could also be used to decorate products of any other nature, or rather, having any other shape even not flat and made from any material, without any limitation to the purposes of the present invention.

The machine 1 comprises, in a per se known manner, a frame or base, not indicated in the figures for the sake of simplicity, which supports its various groups and components, which shall be better described in the rest of the description.

According to one aspect of the present invention, the machine 1 comprises a digital printing head 2 for applying, on the surface of the products to be decorated 3, at least one layer of fluid adhesive material of the type that hardens by exposure to radiation.

More in detail, the adhesive material forming the layer is preferably of the low viscosity type, which polymerises rapidly when undergoing a radiation of a certain frequency. In such a way the adhesive material, in very brief time periods, takes up the form of a film that is substantially transparent with a glue-like consistency that is suitable for the subsequent deposit of material, as explained in the rest of the description.

According to another aspect of the invention, the machine 1 comprises radiant means 4 that are suitable for irradiating the layer of adhesive material.

As clarified above, the irradiation of the layer of adhesive material, for a suitably set time period, determines its rapid transformation into a substantially transparent and glue-like film that is suitable for the subsequent deposit of materials.

According to another aspect of the present invention, the machine 1 comprises means 5 for depositing granular materials 6 on the layer of adhesive material, after this has undergone irradiation through the radiant means 4 and has thus taken up a glue-like consistency.

In particular, the granular materials 6 to be deposited on the layer of adhesive material can comprise powders, granules, shots, flakes, and the like, or any other material in the granular or substantially granular form that are suitable for making a decoration on the surface of a product 3 with a certain thickness, as better explained in the rest of the description.

According to a further aspect of the present invention, the machine 1 comprises means 7 for removing the excess granular materials 6, which are deposited on the products to be decorated 3 by the means 5 for depositing.

More in detail, after the granular materials 6 have been deposited on the layer of adhesive material, the means 7 for removing suitably provide for eliminating the portions of granular materials 6 which have not stuck directly to the layer of adhesive material, and that therefore remains in excess since they are not able to be incorporated in the decoration that is being made.

The digital printing head 2 for applying the adhesive material, the radiant means 4, the means 5 for depositing the granular materials 6 and the means 7 for removing the excess granular materials are arranged in sequence along an advance direction A of the products to be decorated 3, as clearly illustrated in FIG. 1.

The machine 1 also comprises means 8 for advancing the products 3 along the aforementioned direction A.

The means 8 for advancing the products to be decorated 3 along the direction A can comprise, more in particular, a conveyor belt that is supported by the frame of the machine 1, on which the products to be decorated 3 are fed through the various groups of the machine 1 itself.

In other embodiments of the machine 1 according to the invention, the means 8, for advancing the products to be decorated 3, could be of an equivalent type, for example with rollers, belts, or the like.

The digital printing head 2, more in particular, is provided with one or more respective single heads, the latter being each equipped with nozzles for ejecting fluid adhesive material on the upper surface of the products 3 to be decorated.

As mentioned, in order to be able to be dispensed by the ejection nozzles of the aforementioned print head, the adhesive material must be suitably of the low viscosity type.

It is worth noting that printing heads 2 of this type are already used in the field of decorating ceramic tiles, and in other similar fields, mainly for applying inks or other printing fluids.

Each single head of the digital printing head 2 is suitable for dispensing—through ejection nozzles for example of the piezoelectric controlled type—a controlled amount, per unit time, of microdrops of fluid of various nature intended to be deposited on the surface of the product.

For example, a printing head of this type is described, in its main structural characteristics, in European patent n. EP 2093065 to the same Applicant.

The digital printing head 2 can be mounted on a respective box able to slide perpendicularly with respect to the forward movement direction A, which makes it possible to easily carry out all maintenance operations.

The dispensing of adhesive material through a digital printing head 2 equipped with ejection nozzles with, for example, a piezoelectric-type control—or of another equivalent type—makes it possible to apply, on the surface of the products to be decorated 3, a layer of material that fully covers or that covers according to a specific pattern, also complex, with optimal precision and accuracy, without limitations.

In other words, it is possible to deposit with extreme precision, through a digital printing head 2 of this type, the layer of adhesive material also only on some areas of the surface of the product to be decorated 3, according to a desired pattern and as a function of the type of end decoration to be obtained: the layer of adhesive material can thus be substantially continuous and even, or made up of many separate portions that are applied in the desired areas.

In this way, the subsequent depositing of granular materials 6 occurs only at the layer of adhesive material, applied according to the aforementioned predetermined pattern: the portions of granular materials 6 that are not deposited on the layer of adhesive material can be then easily removed through removing means 7.

It should however be noted that, in relation to the specific production requirements, the digital printing head 2 of the layer of adhesive material on the surface of the products to be decorated 3 could also be replaced by other application means of a different type but equivalent in terms of the results that can be obtained, without any limitation to the purposes of the present invention.

The radiant means 4 comprise at least one or more lamps for emitting light.

The light emitted by the lamp 4 is preferably ultraviolet.

The lamp 4 is supported by the frame of the machine 1 so as to have the radiating surface that is positioned near to the upper surface of the products to be decorated 3, as illustrated in FIG. 1.

In other embodiments, the radiant means 4 could comprise one or more lamps for emitting light radiation having different frequency, for example visible light or others, in relation to the specific application requirements.

The means 5 for depositing granular material 6 comprise, more in detail, at least one hopper 9 that contains the granular materials 6 themselves, and at least one device 10 for distributing the granular materials 6 on the layer of adhesive material already previously applied onto the product 3.

The hopper 9 is supported by the frame of the machine 1 at a suitable height with respect to the plane of the advancing means 8.

The distribution device 10 of the granular materials 6 is positioned right below the hopper 9.

In the embodiment of the machine 1 represented in FIG. 1, the distribution device 10 comprises a vibrating surface that is suitable for causing the granular material 6 to fall on the layer of adhesive material previously deposited.

Alternatively, the distribution device 10 could comprise a rotating surface that is suitable for causing the granular material 6 to fall on the layer of adhesive material previously deposited.

The distribution of the granular materials 6 through a vibrating or rotating surface 10 makes it possible to obtain an even deposit of materials 6 themselves on the various areas of the layer of adhesive material previously applied. The means 7 for removing the excess granular materials 6 comprise, more in particular, at least one suction hood 11. The suction hood 11 is supported by the frame of the machine 1 at a suitable height with respect to the plane of the advancing means 8.

More in detail, the suction hood 11 is positioned so that its suction mouth 12 is near to the upper surface of the products to be decorated 3.

The suction hood 11 also comprises a discharge mouth 13 through which, through suitable ducts, not represented in the figures, the excess granular materials 6 can be, for example, sent again inside the hopper 9, or conveyed to a special collection area.

In other embodiments, the means 7 for removing the excess granular materials 6 could be of another equivalent type.

For example, the removing means 7 could consist of a vibrating surface on which the product 3 is arranged, or of a surface removal mechanical member like a spatula, a brush or the like.

A method for decorating products with granular materials and the like, carried out with the machine 1 previously described, also forms the object of the present invention.

The products 3 move, inside the machine 1, on the advancing means 8 along the direction A.

The advancing speed of the products 3 along the direction A is suitably selected based upon the time intervals necessary for carrying out the various steps of the method.

The advancing speed of the products 3 along the direction A can also be variable, or rather it can be increased or lowered at the various groups of the machine 1, i.e. when the various steps of the decoration method are carried out.

If necessary, the products 3 can also pause at one or more groups of the machine 1 for the time necessary.

The decoration method according to the invention thus comprises an initial step of applying, on the surface of the products to be decorated 3, at least one layer of fluid adhesive material, of the type that hardens through exposure to radiation.

The step of applying the layer of adhesive material is carried out through the digital printing head 2 previously described.

The application of the layer of adhesive material can occur, as mentioned, with substantially full coverage, or rather without distinction between the various areas of the surface of the product to be decorated 3, or it can be limited to certain set areas of the surface of the product 3, in relation to the decoration pattern that is desired to be made.

The method then foresees a step of irradiating the layer of adhesive material already applied, through the ultraviolet light lamp 4, or through a lamp of another type. This radiating step is carried out for a suitable set period of time that is sufficient so as to ensure that the fluid adhesive material is transformed into a substantially transparent film with a glue-like consistency.

There is then a step of depositing granular material 6 on the layer of adhesive material: this step is carried out through depositing means 5.

More in detail, the granular materials 6 fall from the lower opening of the hopper 9 and are deposited on the layer of adhesive material, which has already taken up a glue-like consistency, through the distribution device 10, which, as already mentioned, consists of a vibrating surface.

The granular materials 6 are deposited so as to completely cover at least the layer of adhesive material.

If the layer of adhesive material has been previously applied with full coverage, the distribution of the granular materials 6 must also have full coverage.

The deposited granular materials 6, therefore, stick to the layer of adhesive material, so as to create a certain decorative pattern that has the characteristics, for example chromatic characteristics, of the deposited material.

Following the deposit of granular materials 6, the method foresees a step of removing the excess granular materials 6 themselves, or rather, those that did not directly stick to the layer of adhesive material.

The excess granular materials 6, more in detail, are directly and rapidly sucked by the suction hood 11, and possibly sent again into the hopper 9, in the case in which they can be reused for a new depositing cycle.

The excess granular materials 6 can, for example, consist of those portions of material that were not deposited on the layer of adhesive material, in the case in which the latter was only applied in some areas of the surface of the product to be decorated to obtain a certain decorating pattern.

According to one very important aspect of the present invention, the method described above can be applied many times in sequence, for example by arranging in series many machines 1 of the described type.

In particular, the method can be applied many times in sequence so as to make different layers of granular materials 6 on top of one another, or to deposit granular materials 6 of a different type at different areas of the surface of the product to be decorated 3.

As can be understood, the solid and three-dimensional effect which is desired to be obtained in the end product, and that forms the object of the present invention, is indeed made thanks to the possibility of arranging different layers of granular materials 6, deposited on top of one another or foreseen in separate areas of the surface of the product 3 itself.

In such a way, for example, thicknesses of the decoration can be obtained having sizes that cannot be obtained with conventional technologies, and that can also be adjusted as desired in relation to the different areas of the product to be decorated 3.

Together with the above features, also different chromatic effects can be obtained associated with the various areas with different thickness.

It is thus clear that the method makes it possible to obtain an endless variety of results—in terms of thickness of the decoration and in terms of chromatic effects—which cannot be obtained with conventional decoration technologies.

In the particular case in which the products to be decorated 3 consist of ceramic tiles, these are normally decorated at the surface, through the machine and method previously described, when they are at the so called “green” state, i.e. that have not yet undergone cooking.

The following and necessary cooking step—known per se—that the ceramic tiles 3 normally undergo, causes the melting of the deposited granular materials 6, so as to create decorative layers, even partially or completely overlapping one another, which are compact and even with the desired thickness, with the desired mechanical and aesthetic characteristics.

The electronic management of the machine according to the invention is especially studied to synchronise this application with depositing of granular material to any other form of conventional and analogue digital printing. Another embodiment of the machine according to the present invention is illustrated in FIG. 2.

This embodiment is different from that illustrated in FIG. 1 due to the fact that the distribution device 10 of the means 5 for depositing of the granular materials 6 comprises a belt that is suitable for transferring the granular materials 6 themselves falling from the hopper 9 onto the layer of adhesive material already previously deposited.

A distribution device 10 of this kind is more efficient than the previous one in obtaining, in particular, decorations that are uniform with full coverage.

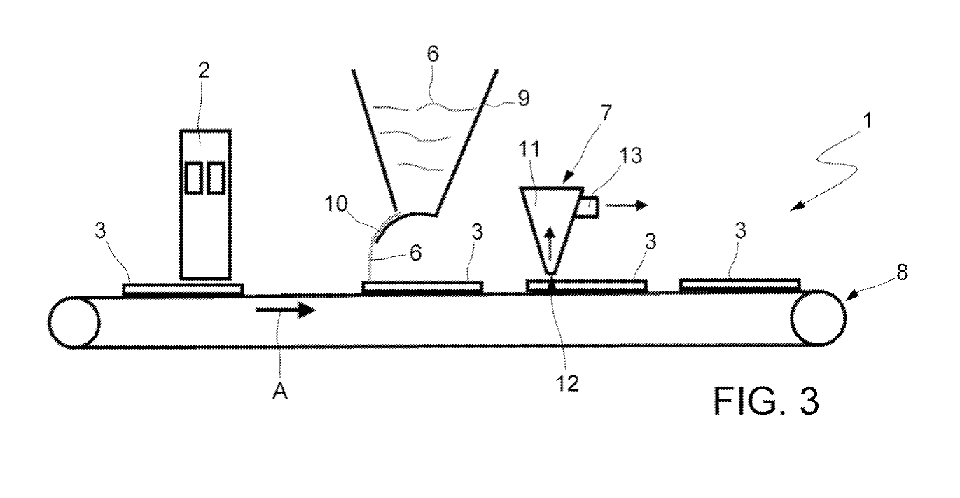

One simplified embodiment of the machine according to the present invention is illustrated in FIG. 3.

This embodiment of the machine is different from that of FIG. 1 in that the digital printing head 2 provides for applying, on the products to be decorated 3, fluid adhesive material of the type that does not harden through exposure to radiation, but of another type that is suitable for the application.

In particular, fluid adhesive materials can be used that take up a sticky consistency when in contact with air. Or, fluid adhesive materials can be used which take up a sticky consistency in contact with a so-called “primer” previously spread on the entire surface of the product to be decorated 3, or also only on part of it.

Consequently, in this embodiment of the machine it is not foreseen for there to be radiant means for hardening the adhesive material.

The digital decoration method that is obtained with this machine, therefore, is identical to the one previously described except for the fact that it is not foreseen for there to be a step of irradiating the adhesive material applied by the digital printing head 2.

It has thus been seen how the invention achieves the proposed purposes.

The present invention has been described according to preferred embodiments but equivalent variants can be conceived without departing from the protection offered by the following claims.

1. A machine for the digital decoration of products with granular materials and the like, comprising:
at least one digital printing head for the application, on the surface of the products to be decorated, of at least one layer of fluid adhesive material;
means for depositing granular materials on the adhesive material layer; and
means for removing the excess granular materials.

2. The machine according to claim 1, wherein said digital printing head comprises one or more respective heads provided each with piezoelectric control nozzles for the controlled ejection of microdrops of fluid adhesive material on the top surface of the products to be decorated.

3. The machine according to claim 1, wherein said fluid adhesive material is of the hardening type by exposure to a radiation.

4. The machine according to claim 3, comprising radiant means adapted to radiate the adhesive material layer.

5. The machine according to claim 4, wherein said radiant means comprise at least one ultraviolet light emission lamp.

6. The machine according to claim 1, wherein said depositing means comprise at least one hopper containing the granular materials, and a distribution device of the granular materials on the adhesive material layer.

7. The machine according to claim 6, wherein said distribution device comprises a vibrating or rotating surface suitable for determining the dropping of the granular materials onto the adhesive material layer.

8. The machine according to claim 6, wherein said distribution device comprises a tape suitable for transferring the granular materials dropping from said hopper onto the adhesive material layer.

9. The machine according to claim 1, wherein said removing means comprise at least one suction hood.

10. The machine according to claim 4, wherein said digital printing head, said radiant means, said depositing means and said removing means are arranged in a sequence along an advance direction (A) of the products to be decorated.

11. The machine according to claim 10, comprising advancing means of the products to be decorated along said direction (A).

12. The machine according to claim 1, wherein said adhesive material is of the type that assumes sticky consistency in contact with the air or in contact with a primer that has been previously spread on the surface of the product to be decorated.

13. A method for the digital decoration of products with granular materials and the like, comprising the steps of:
applying, on the surface of the products to be decorated, at least one layer of fluid adhesive material;
depositing granular materials on the adhesive material layer; and
removing the excess granular materials.

14. The method according to claim 13, wherein said step of applying at least one layer of fluid adhesive material comprises ejecting microdrops of adhesive material on the surface of the products to be decorated by means of a digital printing head with heads provided with piezoelectric control nozzles.

15. The method according to claim 13, wherein said fluid adhesive material is of the hardening type by exposure to a radiation.

16. The method according to claim 15, comprising a step of radiating the adhesive material layer.

17. The method according to claim 16, wherein said step of radiating the adhesive material layer comprises radiating ultraviolet light.

18. The method according to claim 13, wherein said step of depositing comprises distributing by dropping the granular materials onto the adhesive material layer.

19. The method according to claim 13, wherein said step of removing comprises drawing the excess granular materials.

20. A method for the digital decoration of products with granular materials and the like, wherein it is carried out with a machine according to claim 1.
